(19) United States
(12) Patent Application Publication
(10) Pub. No.: US 2025/0006439 A1
(43) Pub. Date: Jan. 2, 2025

(54) ELECTRONIC DEVICE, PUSH-TYPE INPUT DEVICE, AND ELECTRONIC SHIFTER

(71) Applicant: ALPS ALPINE CO., LTD., Tokyo (JP)

(72) Inventors: Ryo FUJISHIMA, Miyagi (JP); Genki TAKEUCHI, Miyagi (JP)

(21) Appl. No.: 18/884,786

(22) Filed: Sep. 13, 2024

Related U.S. Application Data
(63) Continuation of application No. PCT/JP2023/007248, filed on Feb. 28, 2023.

(30) Foreign Application Priority Data
Apr. 28, 2022 (JP) 2022-074591

(51) Int. Cl. H01H 13/803; F16H 59/02; H01H 13/81; H01H 13/85

(52) U.S. Cl. CPC H01H 13/803; F16H 59/02; H01H 13/81; H01H 13/85; F16H 2059/0221

(57) ABSTRACT

An electronic device includes a sensor connected to a power supply, a first load connected to the power supply, a sensor control unit configured to control the sensor, and a drive control unit configured to control drive of the first load, wherein the sensor control unit is configured to acquire a detection value from the sensor in synchronization with a drive cycle by which the drive control unit performs drive control of the first load.

This application is a continuation application of International Application No. PCT/JP2023/007248, filed on Feb. 28, 2023, and designated the U.S., which is based upon and claims priority to Japanese Patent Application No. 2022-074591, filed on Apr. 28, 2022, the entire contents of which are incorporated herein by reference.

### BACKGROUND OF THE INVENTION

### 1. Field of the Invention

The present disclosure relates to electronic devices, push-type input devices, and electronic shifters.

### 2. Description of the Related Art

Conventionally, in a device on which a plurality of loads requiring large power are mounted, when each load is controlled to be on or off in a predetermined cycle, there is a power supply voltage fluctuation preventing method to prevent fluctuations in the power supply voltage that occur when each load is turned on or off. A duty cycle representing an on-duration from a start time of driving to an end time of driving with respect to one cycle of each load is determined based on a temperature detected by a temperature sensor before the start time of driving of each load, and a drive timing is set based on the determined duty cycle so that the start time of driving and the end time of driving of each load do not coincide with each other (e.g., see PTL (Patent Literature) 1).

A conventional voltage fluctuation preventing method sets the drive timing so that the start time and the end time of the on-duration of each load determined based on the temperature detected by the temperature sensor do not coincide with each other in order to prevent the fluctuation of the power supply voltage that occurs when the load is turned on or off.

Therefore, the present disclosure aims to provide an electronic device capable of preventing the influence of the fluctuation of the power supply voltage and obtaining the detection value of the sensor with stable accuracy, a push-type input device, and an electronic shifter.

### CITATION LIST

### Patent Literature

[PTL 1] Japanese Laid-Open Patent Publication No. 2000-066738

### SUMMARY OF THE INVENTION

An electronic device of the embodiments of the present disclosure includes a sensor connected to a power supply, a first load connected to the power supply, a sensor control unit configured to control the sensor, and a drive control unit configured to control drive of the first load, wherein the sensor control unit is configured to acquire a detection value from the sensor in synchronization with a drive cycle by which the drive control unit performs drive control of the first load.

### Effects of the Invention

An electronic device capable of preventing the influence of the fluctuation of the power supply voltage and obtaining the detection value of a sensor with stable accuracy, a push-type input device, and an electronic shifter can be provided.

### BRIEF DESCRIPTION OF THE DRAWINGS

FIG. 1 is an external perspective view of a push-type shifter device according to an embodiment;

FIG. 2 is an exploded perspective view of the push-type shifter device according to an embodiment;

FIG. 3 is a perspective cross-sectional view of the push-type shifter device according to an embodiment;

FIG. 4 is a partially enlarged perspective cross-sectional view of the push-type shifter device according to an embodiment;

FIG. 5 is a drawing illustrating an electrical configuration of the push-type shifter device according to an embodiment;

FIG. 6 is an external perspective view of slider included in the push-type input device according to an embodiment;

FIG. 7 is a side view of a rotating body included in the push-type input device according to an embodiment;

FIG. 8 is a drawing illustrating engagement between an upper sliding unit and a lower sliding unit of the slider and a cam unit of the rotating body in the push-type input device according to an embodiment;

FIG. 9 is a drawing illustrating engagement between the upper sliding unit and the lower sliding unit of the slider and the cam unit of the rotating body in the push-type input device according to an embodiment;

FIG. 10A is a drawing illustrating a configuration of a magnetic sensor 107C;

FIG. 10B is a drawing illustrating an example of waveforms of a +SIN signal 1 and a −SIN signal 1 output by the magnetic sensor 107C;

FIG. 10C is an enlarged view of an angle range AR;

FIG. 11 is a drawing illustrating an example of a configuration of a peripheral circuit of LED elements 107B1 and 107B2 of the push-type input mechanisms 100-1 to 100-4 of the push-type shifter device 10;

FIG. 12 is a drawing illustrating an output voltage VREFH of a power supply 1, a PWM signal 1, and a PWM signal 2;

FIG. 13 is a drawing illustrating an example of a processing table of a light emission control unit 121; and

FIG. 14 is a flowchart illustrating a processing executed by the light emission control unit 121 and a sensor control unit 122 of a controller 120.

### DESCRIPTION OF THE PREFERRED EMBODIMENTS

Embodiments of the present disclosure of the electronic device, the push-type input device, and the electronic shifter of the present disclosure will be described below.

### Embodiments

### (Summary of Push-Type Shifter Device 10)

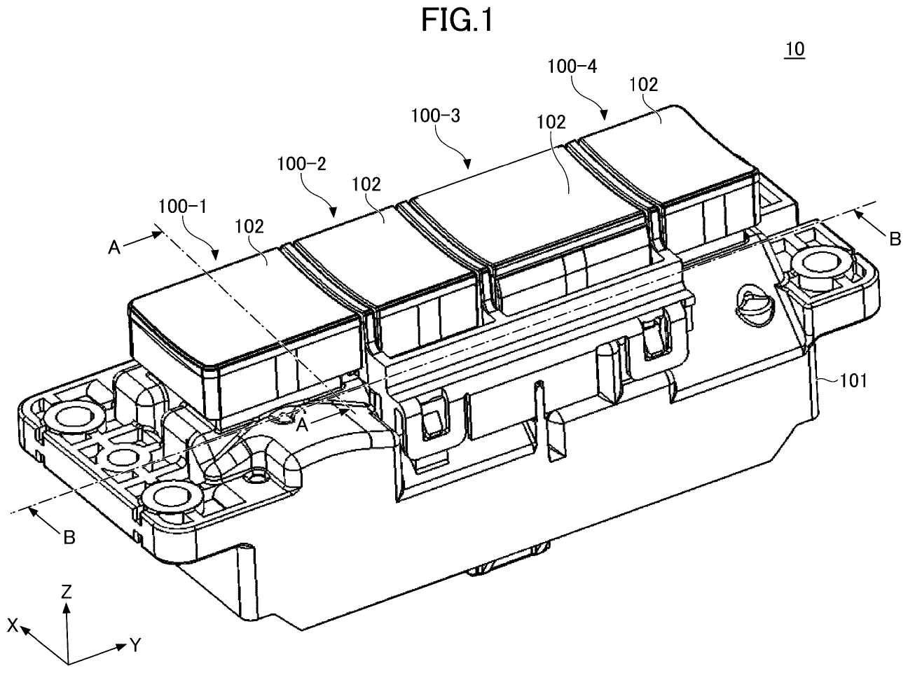

FIG. 1 is an external perspective view of a push-type shifter device 10 according to an embodiment. The push-type shifter device 10 is an example of a push-type input device and an example of an electronic shifter. In the following description, for the sake of convenience, an X-axis direction is a front-rear direction, a Y-axis direction is a left-right direction, and a Z-axis direction is a vertical direction. Here, an X-axis positive direction is a forward direction, a Y-axis positive direction is a right direction, and a Z-axis positive direction is an upward direction. These indicate the relative positional relation within the device, and do not limit the installation direction or the operation direction of the device. All devices having the same relative positional relation within the device, even those having different installation directions or operation directions, fall within the scope of the present disclosure.

The push-type shifter device 10 shown in FIG. 1 is a device installed in a vehicle such as an automobile to receive an operation to select a shift position of the vehicle. As shown in FIG. 1, the push-type shifter device 10 includes four push-type input mechanisms 100 (100-1 to 100-4) and a case 101. The four push-type input mechanisms 100 are arranged in a line in the left-right direction (Y-axis direction) and are integrated by a single case 101. Each of the four push-type input mechanisms 100 has an operation knob 102 on the uppermost portion thereof, and the operator can perform an operation to select a shift position to the shift position corresponding to the operation knob 102 by pushing the operation knob 102.

### (Configuration of the Push-Type Input Mechanism 100)

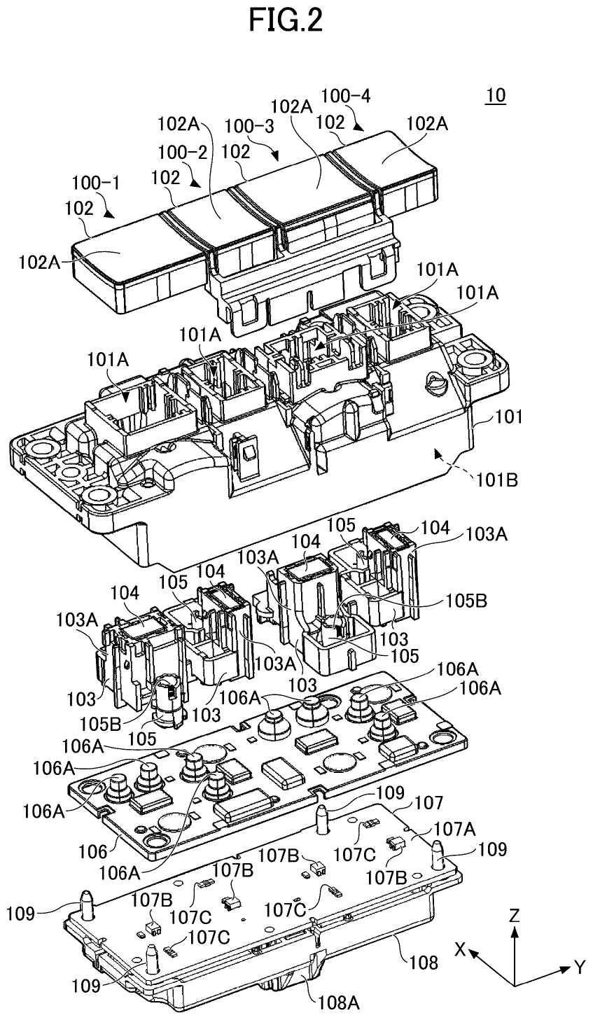

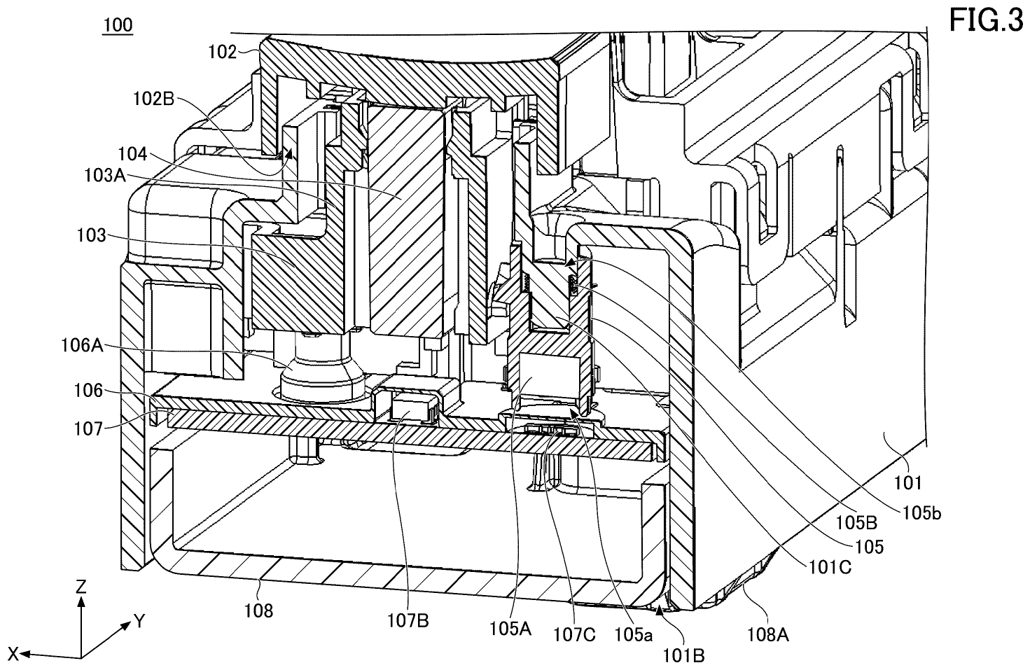

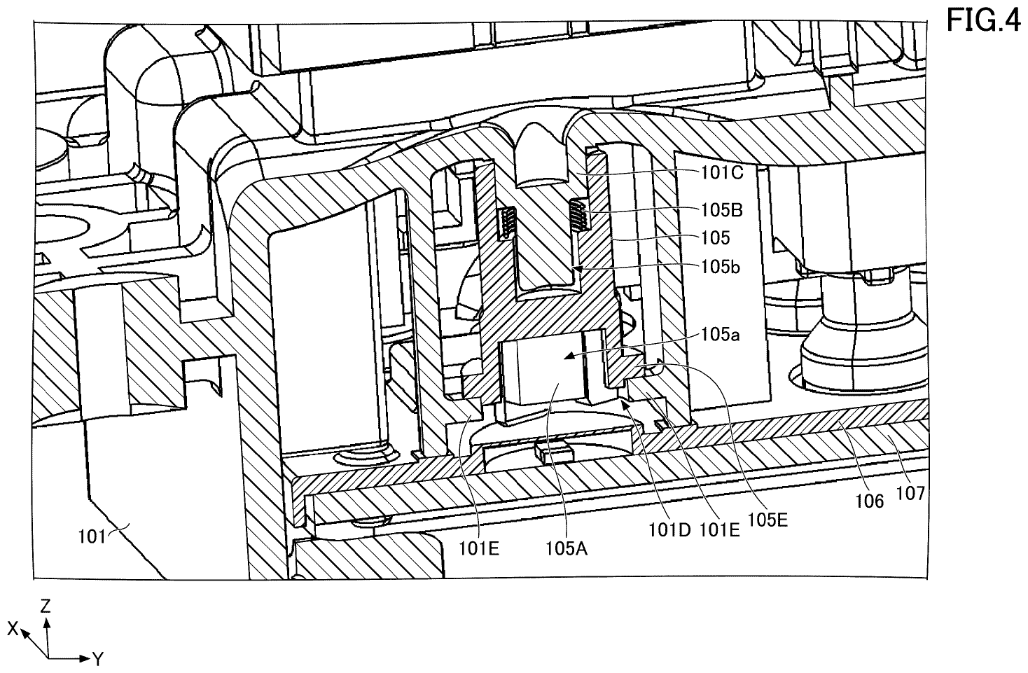

FIG. 2 is an exploded perspective view of the push-type shifter device 10 according to an embodiment. FIG. 3 is a perspective cross-sectional view of the push-type shifter device 10 according to an embodiment. FIG. 4 is a partially enlarged perspective cross-sectional view of the push-type shifter device 10 according to an embodiment. FIG. 3 shows a cross-section of the push-type input mechanism 100-1 included in the push-type shifter device 10 in the XZ plane (a cross section along the A-A cross section line shown in FIG. 1). FIG. 4 shows a cross section of the push-type input mechanism 100-1 (particularly, rotating body 105) included in the push-type shifter device 10 in the YZ plane (a cross section along the B-B cross section line shown in FIG. 2).

As shown in FIG. 2, each of the four push-type input mechanisms 100-1 to 100-4 includes an operation knob 102, a case 101, a slider 103, a light guide 104, a rotating body 105, a rubber sheet 106, a substrate 107, and a cover 108.

The operation knob 102 is a resin component that receives a push operation from an operator. The operation knob 102 is an example of a switch. In the example shown in FIG. 2, the operation knob 102 has a substantially rectangular parallelepiped shape. The upper surface of the operation knob is an operation surface 102A that is substantially horizontal and slightly curved in a concave shape for receiving a push operation. The entire portion corresponding to the lower surface of the operation knob 102 is a lower opening 102B. The operation knob 102 is fixedly attached to the upper portion of the slider 103 by fitting the upper portion of the slider 103 into the lower opening 102B from the lower side (Z-axis negative side). Thus, the operation knob 102 can move in the vertical direction (Z-axis direction) integrally with the slider 103. That is, the operation knob 102 can slide the slider 103 downward (Z-axis negative direction) by performing a push operation on the operation surface 102A.

Each operation knob 102 has a translucent portion representing the shape of a symbol representing a shift position, and when the LED 107B on the lower side emits light, the light guided by the light guide 104 passes through, thereby illuminating the symbol.

The case 101 is a container-like and resin-made component having a substantially rectangular parallelepiped shape and a hollow structure. A slider 103, a light guide 104, a rotating body 105, a rubber sheet 106, and a substrate 107 are accommodated in the case 101. An upper opening 101A having a rectangular shape in a plan view is formed on the upper surface of the case 101. A slider 103 is arranged in the upper opening 101A so as be slidable in the vertical direction (Z-axis direction). The entire portion of the case 101 corresponding to the lower surface is a lower opening 101B. The lower opening 101B is closed by the cover 108. As shown in FIG. 3, a tubular shaft unit 101C is provided in the case 101 so as to hang from the ceiling surface. As shown in FIG. 3, the shaft unit 101C is inserted into the upper opening 105b of the rotating body 105 to rotatably support the upper portion of the rotating body 105. Further, as shown in FIG. 4, a pair of supporting units 101E facing each other with a bearing opening 101D interposed therebetween are provided inside the case 101. Further, as shown in FIG. 4, a flange 105E enlarged in the radial direction from the outer peripheral surface of the rotating body 105 is provided at the lower end portion of the rotating body 105. The diameter of the flange 105E is larger than the diameter of the bearing opening 101D. As shown in FIG. 4, the lower end portion of the rotating body 105 is fitted into the bearing opening 101D. At this time, the flange 105E of the rotating body 105 abuts on the upper surfaces of the pair of supporting units 101E. Thus, the lower portion of the rotating body 105 is rotatably supported, that is, the downward movement of the rotating body 105 is restricted.

The slider 103 is a resin component arranged in the upper opening 101A of the case 101 so as to be slidable in the vertical direction (Z-axis direction) (one example of the “predetermined sliding direction”). The slider 103 has a tubular unit 103A having a substantially square tubular shape with the vertical direction (Z-axis direction) as the tubular direction.

The light guide 104 is a component made of resin and having a square columnar shape and disposed in the tubular unit 103A of the slider 103. The light guide 104 emits light emitted from the LED 107B mounted on the upper surface 107A of the substrate 107 and incident from the bottom surface of the light guide 104 from the upper surface of the light guide 104. As a result, the light guide 104 guides the light emitted from the LED 107B to the operation knob 102.

The rotating body 105 is a generally tubular member having a vertical direction as a tubular direction. The rotating body 105 is disposed on the side of the slider 103 so as to be rotatable about the axis of the rotation axis with a vertical direction (Z-axis direction) as the axis direction of the rotation axis. The outer peripheral surface of the rotating body 105 is engaged with the slider 103 so as to be rotated in accordance with the vertical sliding of the slider 103 (details of the engagement will be described later). As shown in FIG. 3, a magnet 105A is embedded in the lower opening 105a of the rotating body 105. As shown in FIG. 3, a shaft unit 101C of the case 101 is inserted into the upper opening 105b of the rotating body 105. Thus, the rotating body 105 is rotatably supported by the case 101. An annular torsion spring 105B (an example of “biasing means”) is provided around the shaft unit 101C of the case 101 in the upper opening 105b of the rotating body 105. One end of the torsion spring 105B is fixed to the shaft unit 101C, and the other end of the torsion spring 105B is fixed to the rotating body 105. As a result, the rotating body 105 is always biased counterclockwise when viewed from above by the elastic force generated by the torsion spring 105B. The rotating body 105 rotates clockwise when viewed from above in accordance with the downward sliding (Z-axis negative direction) of the slider 103 by the push operation, and then can rotate counterclockwise when viewed from above (return rotation direction) by the elastic force generated by the torsion spring 105B when the push operation is released. As a result, the rotating body 105 can rotate to the initial position of the rotating body 105 and return to the initial position when the rubber dome 106A of the rubber sheet 106, which will be described later, pushes the slider 103 upward (Z-axis positive direction) and the slider 103 returns to the initial position before the push operation.

The rubber sheet 106 is a sheet-like member provided over the upper surface 107A of the substrate 107. The rubber sheet 106 is formed of an elastic material (e.g., silicone rubber, etc.). Since the rubber sheet 106 covers the upper surface 107A of the substrate 107 over the entire area, even when water enters the inside of the case 101, it is possible to prevent the upper surface 107A of the substrate 107 from being covered with water.

Two rubber domes 106A are integrally formed on the rubber sheet 106 at positions opposed to the bottom surfaces of the sliders 103. Each rubber dome 106A is an example of a “click feeling imparting mechanism”. Each rubber dome 106A is formed in a convex shape protruding upward from the upper surface of the rubber sheet 106. When the push operation is performed, each rubber dome 106A is pressed by the bottom surface of the slider 103 to elastically deform (inversely bend) its dome portion, thereby imparting a click feeling to the push operation. Further, as described above, when the push operation is released, each rubber dome 106A can push the slider 103 upward (in the positive Z-axis direction) by the elastic force (force to return to the initial shape) generated by the rubber dome 106A, thereby returning the slider 103 to the initial position before the push operation.

The substrate 107 is a flat plate-shaped component. The substrate 107 has a square shape in a plan view. Within the case 101, the substrate 107 is fixedly installed on the upper surface of the cover 108 in a horizontal posture with respect to the XY plane. For example, a PWB (Printed Wiring Board) is used as the substrate 107. An LED (Light Emitting Diode) 107B and a magnetic sensor 107C are mounted on an upper surface 107A of the substrate 107.

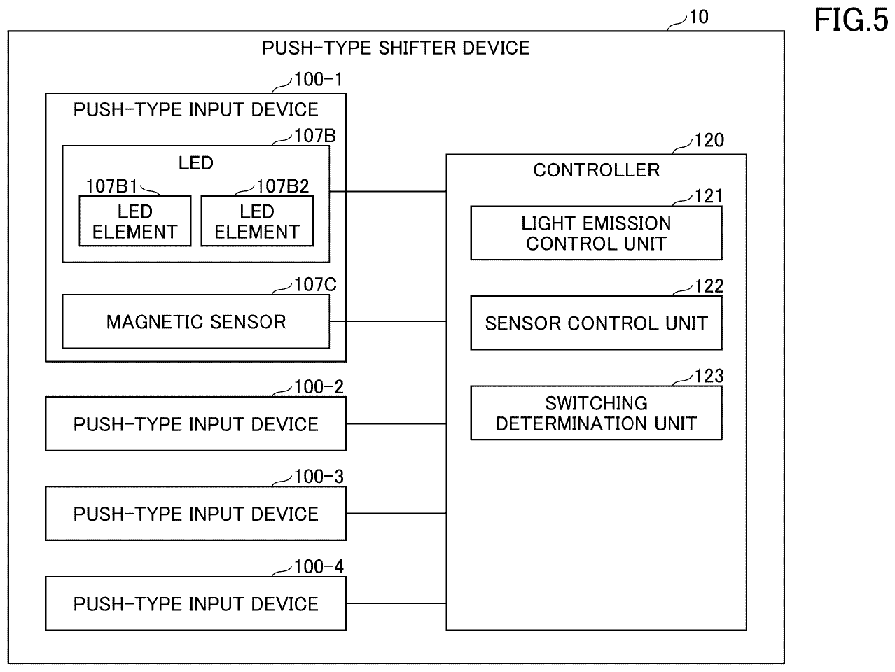

The LED 107B is provided at a position directly under the light guide 104. The LED 107B can emit light under the control of a controller 120 (see FIG. 5) provided on the outside. By emitting light, the LED 107B can emit light into the light guide 104. As an example, as shown in FIG. 5, the LED 107B includes an LED element 107B1 emitting orange light and an LED element 107B2 emitting white light. The LED element 107B1 emitting orange light is an example of a first load, and the LED element 107B2 emitting white light is an example of a second load.

Each LED 107B is driven and controlled by the light emission control unit 121 of the controller 120 described later, and either the orange LED element 107B1 or the white LED element 107B2 is turned on to emit light, and the other is turned off to not emit light. Among the push-type input mechanisms 100-1 to 100-4, the orange LED element 107B1 is turned on for the LED 107B of one push-type input mechanism 100 to which the operation knob 102 is pushed, and the white LED element 107B2 is turned on for the LEDs 107B of the remaining three push-type input mechanisms 100 to which the operation knob 102 is not pushed.

In each push-type input mechanism 100, the orange LED element 107B1 is turned on when the operation knob 102 is pushed, and the white LED element 107B2 is turned on when the operation knob 102 is not pushed. In each push-type input mechanism 100, the orange LED element 107B1 and the white LED element 107B2 are not turned on at the same time, but one of them is turned on. Therefore, the operator can check which of the 4 operation knobs 102 is pushed by the light emission color (illumination color). The light emission state in each push-type input mechanism 100 is maintained until the operator pushes another operation knob 102. The orange color and the white color of the LED elements 107B1 and 107B2 are only examples, and the light emission colors may be any colors different from each other.

The magnetic sensor 107C is provided at a position immediately below the rotating body 105 and faces the magnet 105A provided on the lower end surface of the rotating body 105. The magnetic sensor 107C can detect the rotation angle of the rotating body 105 by detecting a change in the magnetic flux direction accompanying the rotation of the magnet 105A. The magnetic sensor 107C can output a rotation angle signal indicating the detected rotation angle to the controller 120 (see FIG. 5) provided externally via the connector 108A. The push-type input mechanism 100 according to one embodiment uses a magnetic sensor 107C (GMR sensor) as an example of a “sensor” to detect a rotation angle. However, the push-type input mechanism 100 is not limited to this, and may be used as another example of a “sensor” to detect a rotation angle, and may be used as a sensor of another type (e.g., optical, mechanical, electrostatic, resistive, etc.), or a switch which is turned on or off by a push operation may be used as a sensor.

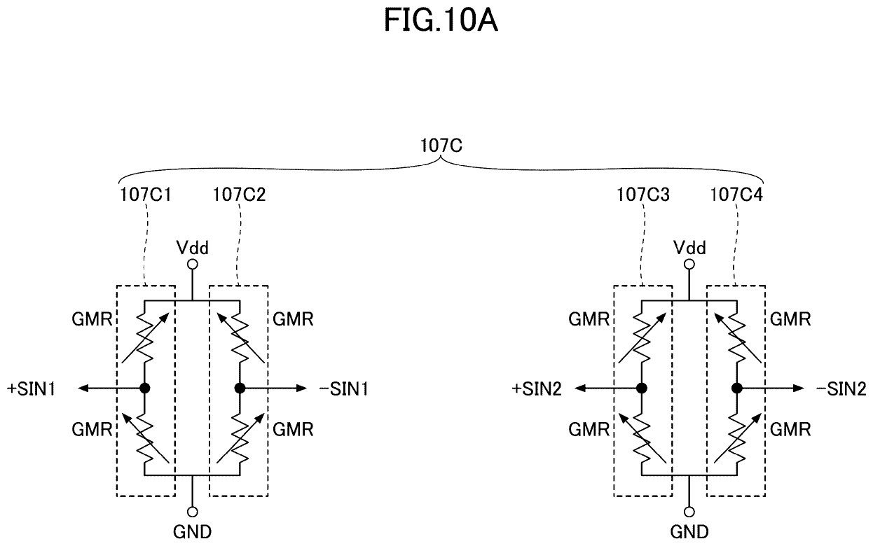

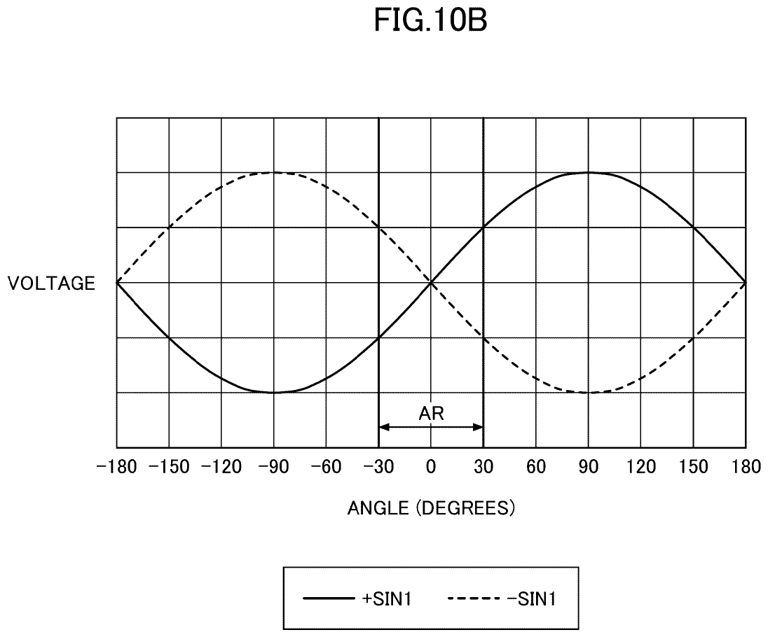

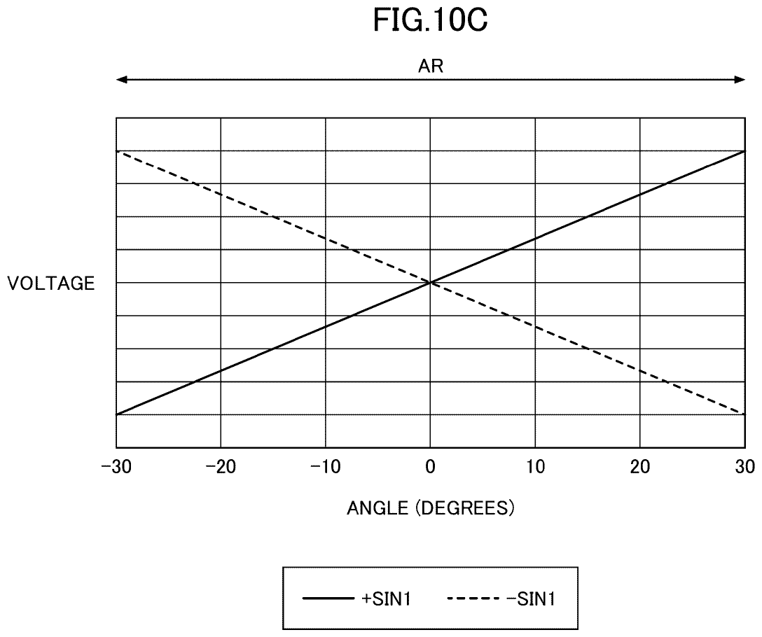

The magnetic sensor 107C has a plurality of GMR elements for detecting a rotation angle of the rotating body 105. The magnetic sensor 107C is an example of a sensor. The configuration of the magnetic sensor 107C will be described later with reference to FIG. 10A.

The cover 108 is a resin-made flat plate component for closing the lower opening 101B of the case 101. The cover 108 is fixed to the case 101 by four screws 109 passing through the cover 108. A rectangular tubular connector 108A is provided on the bottom surface of the cover 108 so as to project downward. A plurality of connector pins (not shown) are arranged inside the connector 108A so as to hang down from the lower surface of the substrate 107. When an external connector (not shown) is fitted into the connector 108A, the plurality of connector pins are electrically connected to the external connector.

### (Electrical Configuration of Push-Type Shifter Device 10)

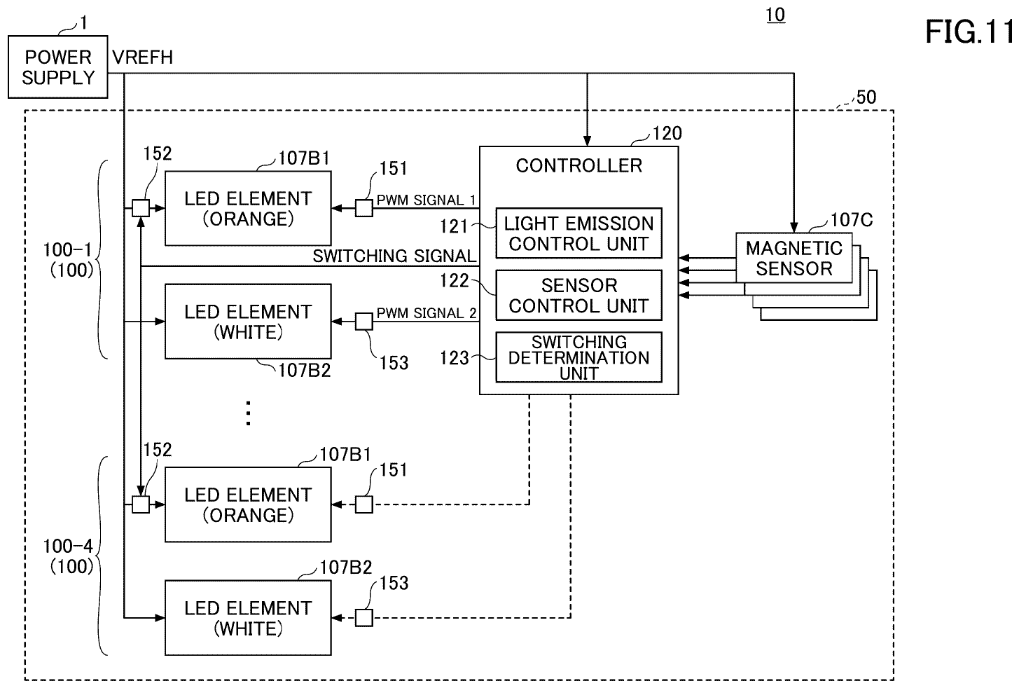

FIG. 5 is a drawing illustrating an electrical configuration of the push-type shifter device 10 according to an embodiment. As shown in FIG. 5, the push-type shifter device 10 includes four push-type input mechanisms 100-1 to 100-4 and a controller 120. Each push-type input mechanism 100 includes the LED 107B and the magnetic sensor 107C. An electronic device according to the embodiment will be described later with reference to FIG. 11.

The controller 120 is connected to the LED 107B and the magnetic sensor 107C provided in each push-type input mechanism 100 via a connector 108A (see FIGS. 2 and 3) provided in the push-type shifter device 10. The controller 120 includes a light emission control unit 121, a sensor control unit 122, and a switching determination unit 123. The light emission control unit 121 is an example of a drive control unit.

The controller 120 is implemented by a computer including a CPU (Central Processing Unit), RAM (Random Access Memory), ROM (Read Only Memory), HDD (Hard Disk Drive), an input and output interface, an internal bus, and the like. The light emission control unit 121, the sensor control unit 122, and the switching determination unit 123 represent functions of programs executed by the controller 120 as function blocks.

The light emission control unit 121 controls the light emission of the LEDs 107B included in each push-type input mechanism 100. When the switching state determined by the switching determination unit 123 indicates that a push operation has been performed, the light emission control unit 121 turns on the orange LED element 107B1 and turns off the white LED element 107B2. When the switching state determined by the switching determination unit 123 indicates that a push operation has not been performed, the white LED element 107B2 is turned on and the orange LED element 107B1 is turned off.

As described above, when the light emission control unit 121 switches between on and off of the orange LED element 107B1 and the white LED element 107B2 of the LED 107B of each push-type input mechanism 100, the operation knob 102 subjected to the push operation is illuminated in orange, and the three operation knobs 102 not subjected to the push operation are illuminated in white. The light emission control unit 121 does not simultaneously turn on the orange LED element 107B1 and the white LED element 107B2 in each push-type input mechanism 100, but turns on one of them and turns off the other of them. When each push-type input device 100 falls into an abnormal state that cannot be seen in normal operation, the switching element 152 is controlled so that the orange LED element 107B1 is not turned on by mistake.

The switching determination unit 123 determines the switching state of the operation knob 102 (an example of a switch) by the push operation for each push-type input mechanism 100 based on the detection signal (i.e., the result of detection of the rotation angle by the magnetic sensor 107C) supplied from the magnetic sensor 107C of each push-type input mechanism 100. The detection signal of the magnetic sensor 107C is acquired by the sensor control unit 122 at a predetermined timing and is passed to the switching determination unit 123. As will be described later in detail, the magnetic sensor 107C outputs, as an example, four measured values in accordance with the operation position of the operation knob 102, and the switching determination unit 123 determines the switching state of the operation knob 102 in accordance with a majority vote based on the measurement level of the four measured values. The switching state indicates whether the push operation is performed or not.

### (Upper Sliding Unit 103B and Lower Sliding Unit 103C of Slider 103)

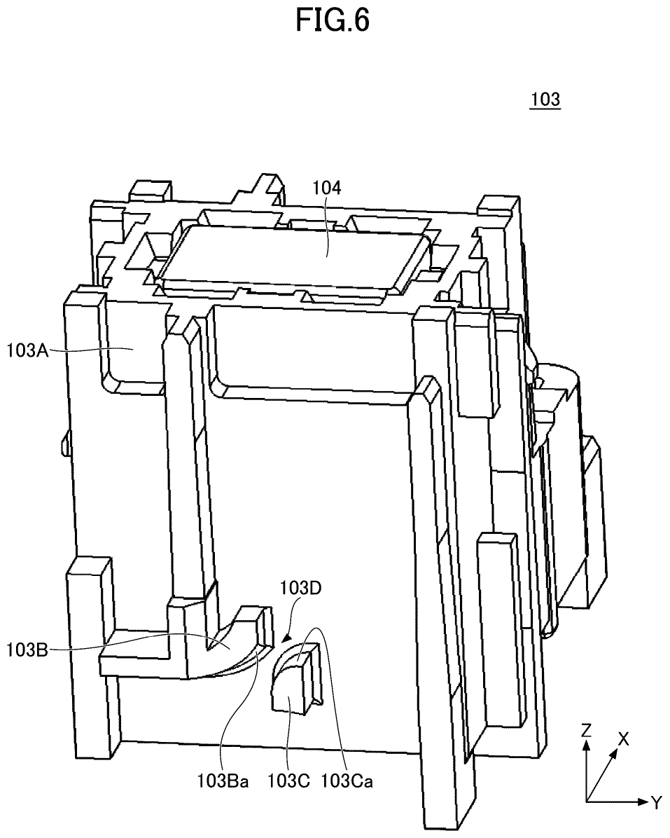

FIG. 6 is an external perspective view of the slider 103 included in a push-type input device 100-1 according to an embodiment. FIG. 6 shows a lateral surface of the rear (X-axis negative direction) of the tubular unit 103A of the slider 103 provided in the push-type input mechanism 100-1. As shown in FIG. 6, the slider 103 provided in the push-type input mechanism 100-1 has an upper sliding unit 103B and a lower sliding unit 103C protruding from the lateral surface of the rear (X-axis negative direction) of the tubular unit 103A.

The upper sliding unit 103B is provided

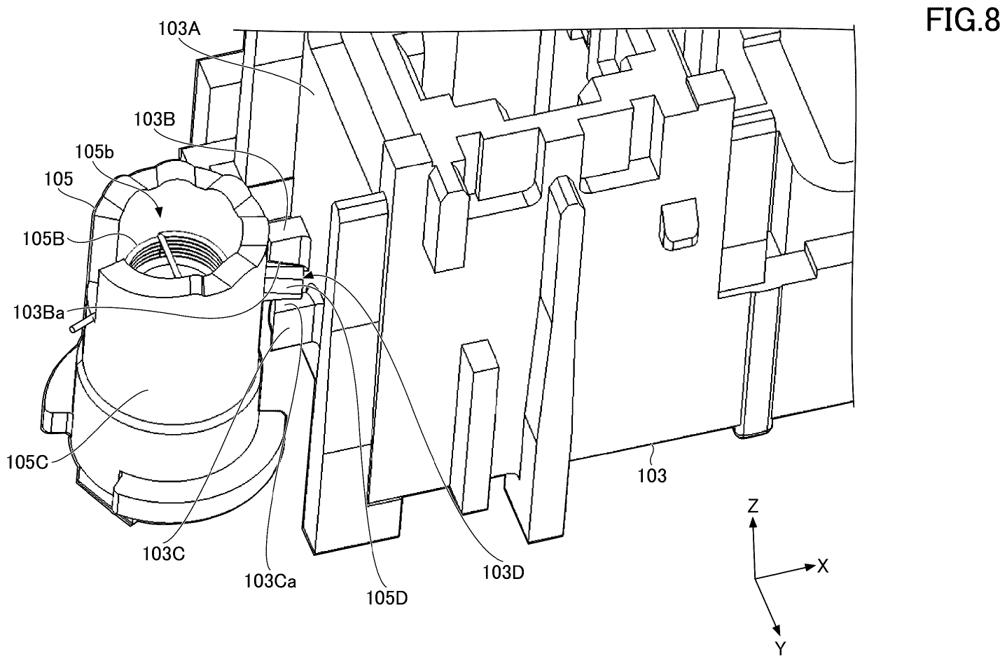

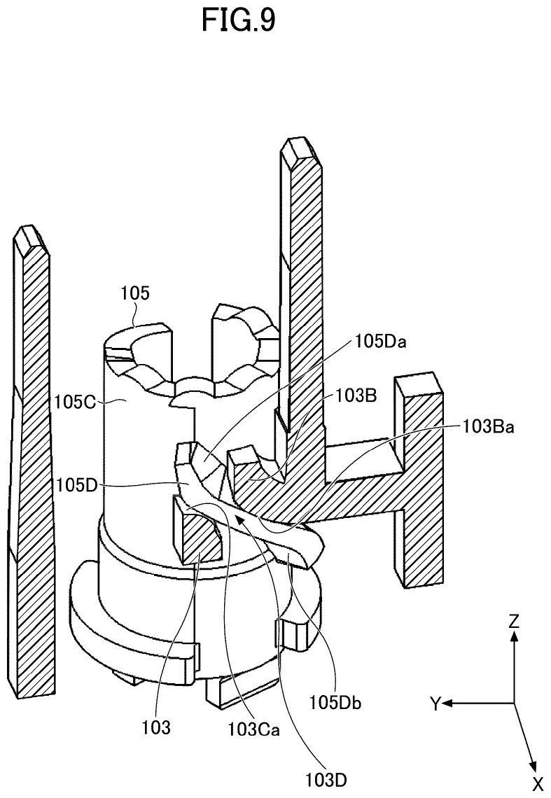

slightly above (Z-axis positive direction) and slightly to the left (Y-axis negative direction) of the lower sliding unit 103C. An opening 103D is formed between the upper sliding unit 103B and the lower sliding unit 103C. The upper sliding unit 103B has a curved upper sliding surface 103Ba facing the opening 103D (convex toward the opening 103D). The lower sliding unit 103C has a curved lower sliding surface 103Ca facing the opening 103D (convex toward the opening 103D). The upper sliding unit 103B and the lower sliding unit 103C are provided at positions facing each other with a cam unit 105D to be described later therebetween (See FIGS. 8 and 9).

### (Cam Unit 105D of Rotating Body 105)

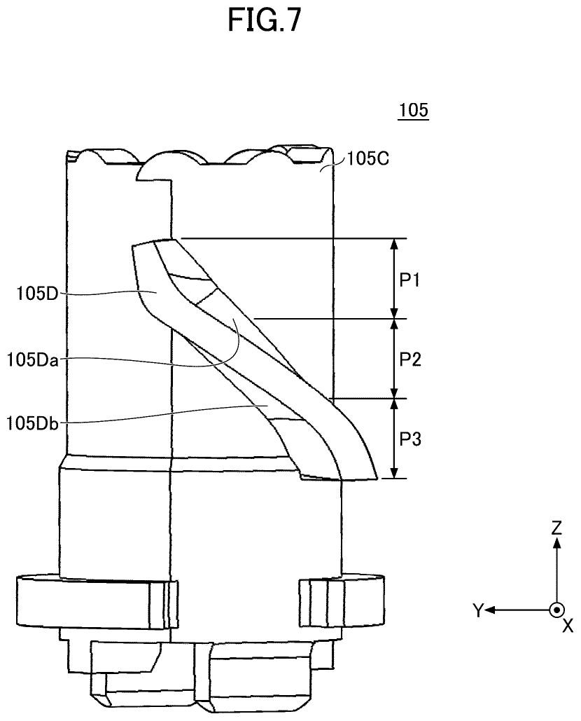

FIG. 7 is a side view of the rotating body 105 included in the push-type input mechanism 100-1 according to an embodiment. FIG. 7 shows a front (positive X-axis) outer peripheral surface 105C of the rotating body 105 included in the push-type input mechanism 100-1. As shown in FIG. 7, a helical cam unit 105D protrudes from a front (positive X-axis) outer peripheral surface 105C of the rotating body 105 included in the push-type input mechanism 100-1. The cam unit 105D extends counterclockwise as viewed from above along the outer peripheral surface 105C from the upper end toward the lower end. The cam unit 105D is spirally formed so that the height thereof gradually decreases from the upper end toward the lower end. The upper inclined surface of the cam unit 105D is an upper cam surface 105Da (an example of a “cam surface”) that is slidable when the upper sliding surface 103Ba (see FIG. 6) of the slider 103 abuts against it. The upper cam surface 105Da converts the sliding force of the slider 103 into the rotating force of the rotating body 105. The rear (lower) inclined surface of the upper cam surface 105Da of the cam unit 105D is a lower cam surface 105Db that is slidable when the lower sliding surface 103Ca (see FIG. 6) of the slider 103 abuts against it.

As shown in FIG. 7, the upper cam surface 105Da has a rotation start portion P1, a rotation intermediate portion P2, and a rotation end portion P3.

The rotation start portion P1 is a portion where the upper sliding unit 103B of the slider 103 slides until the stroke amount of the operation knob 102 reaches the stroke amount S1 (corresponding to the “start of rotation of the rotating body”).

The rotation intermediate portion P2 is a portion where the upper sliding unit 103B of the slider 103 slides until the stroke amount of the operation knob 102 reaches the stroke amount S2 from the stroke amount S1 (corresponding to the “middle of rotation of the rotating body”).

The rotation end portion P3 is a portion where the upper sliding unit 103B of the slider 103 slides when the stroke amount of the operation knob 102 is equal to or greater than the stroke amount S2 (corresponding to the “end of rotation of the rotating body”).

### (Engaged State Between Slider 103 and Rotating Body 105)

FIGS. 8 and 9 are drawings illustrating engagement between the upper sliding unit 103B and the lower sliding unit 103C of the slider 103 and the cam unit 105D of the rotating body 105 in the push-type input device 100-1 according to an embodiment. FIG. 8 is an external perspective view of the slider 103 and the rotating body 105 as seen from above (positive Z-axis direction) and right (positive Y-axis direction). FIG. 9 is a sectional view in the YZ plane of the slider 103 and the rotating body 105 as seen from front (positive X-axis direction), and only the slider 103 shows a sectional view.

As shown in FIGS. 8 and 9, the cam unit 105D of the rotating body 105 is arranged in the opening 103D between the upper sliding unit 103B and the lower sliding unit 103C of the slider 103. Thus, as shown in FIG. 9, the upper cam surface 105Da of the cam unit 105D is slidable in contact with the upper sliding surface 103Ba of the upper sliding unit 103B. As shown in FIG. 9, the lower cam surface 105Db of the cam unit 105D is slidable in contact with the lower sliding surface 103Ca of the lower sliding unit 103C.

Thus, in the push-type input mechanism 100-1 according to an embodiment, when the slider 103 moves downward (in the negative Z-axis direction) according to the push operation of the operation knob 102, the upper sliding surface 103Ba of the upper sliding unit 103B provided on the slider 103 slides the upper cam surface 105Da of the cam unit 105D provided on the rotating body 105 toward the lower end thereof, and the rotating body 105 is rotationally driven clockwise as viewed from above. Thus, in the push-type input mechanism 100-1 according to one embodiment, in accordance with the push operation of the operation knob 102, the rotating body 105 can be rotationally driven clockwise as viewed from above. Further, since the rotating body 105 is always biased counterclockwise (in the return rotation direction) when viewed from above by the elastic force generated by the torsion spring 105B, the upper cam surface 105Da of the cam unit 105D always abuts on the upper sliding surface 103Ba of the upper sliding unit 103B. Therefore, in the push-type input mechanism 100-1 according to one embodiment, the rotating body 105 does not rotate away from the slider 103 even when vibration or impact occurs, and the rotation angle of the rotating body 105 accompanying the push operation can be reliably set in accordance with the amount of downward (negative Z-axis direction) movement of the slider 103.

Further, in the push-type input mechanism 100-1 according to one embodiment, when the push operation of the operation knob 102 is released, the rotating body 105 can be rotated counterclockwise as viewed from above by the elastic force generated by the torsion spring 105B provided in the upper opening 105b of the rotating body 105. Thus, in the push-type input mechanism 100-1 according to one embodiment, while the upper cam surface 105Da of the cam unit 105D provided in the rotating body 105 always contacts and slides with the upper sliding surface 103Ba of the upper sliding unit 103B provided in the slider 103, the rotating body 105 rotates following the upward movement of the slider 103 (in the positive Z-axis direction) by the elastic force of the rubber dome 106A. As a result, in the push-type input mechanism 100-1 according to one embodiment, the slider 103 is pushed upward (in the positive Z-axis direction) by the rubber dome 106A to return the slider 103 to the initial position before the push operation and to return the rotating body 105 to the initial position.

In the push-type input mechanism 100-1 according to one embodiment, the slider 103 has a lower sliding unit 103C. As a result, in the push-type input mechanism 100-1 according to one embodiment, even though the slider 103 is moved upward by the biasing force from the rubber dome 106A when the push operation of the operation knob 102 is released, a failure occurs in the rotation of the rotating body 105 in the return rotational direction (counterclockwise direction as viewed from above) due to the elastic force generated by the torsion spring 105B due to the catching of the rotating body 105 by foreign matter or the like, and the rotation of the rotating body 105 cannot follow the upward movement of the slider 103. When the lower sliding unit 103C of the slider 103, which is separated from the lower cam surface 105Db of the cam unit 105D with a gap in the normal return state, is moved upward by the pushing force of the rubber dome 106A, the lower sliding unit 103C abuts against the lower cam surface 105Db of the cam unit 105D provided on the rotating body 105 that is stopped in place, and the rotating body 105 can be driven to rotate in the return rotational direction (counterclockwise direction as viewed from above) while sliding the lower cam surface 105Db toward the upper end of the cam surface. As a result, the push-type input mechanism 100-1 according to one embodiment can forcibly rotate the rotating body 105 in the return rotational direction (counterclockwise direction as viewed from above) even when the rotating body 105 cannot be driven to rotate only by the elastic force generated by the torsion spring 105B due to the catching of the foreign matter or the like, and can reliably return the rotating body 105 to the initial rotation angle before the push operation.

Furthermore, even if the cam unit 105D or both the upper sliding unit 103B and the lower sliding unit 103C of the slider 103 are damaged and disappear, the push-type input mechanism 100-1 according to one embodiment can restore the rotating body 105 to the initial rotation angle by the biasing force in the return rotation direction from the torsion spring 105B.

The opening 103D between the upper sliding unit 103B and the lower sliding unit 103C is provided with a slight opening relative to the cam unit 105D so that the cam unit 105D can slide smoothly within the opening 103D. This opening may cause the cam unit 105D to wobble within the opening 103D.

However, as described above, the push-type input mechanism 100-1 according to one embodiment biases the cam unit 105D to rotate counterclockwise when viewed from above by the biasing force generated by the torsion spring 105B provided in the rotating body 105. Thus, the push-type input mechanism 100-1 according to one embodiment can always bias the cam unit 105D in a direction in which the cam unit 105D is pressed against the upper sliding unit 103B, that is, by moving the cam unit 105D in one direction in the opening 103D, wobble can be prevented. Therefore, it is possible to prevent the rotation angle of the rotating body 105 from becoming unstable due to the wobble of the cam unit 105D even when the rotating body is subjected to impact or vibration.

Furthermore, as described above, the push-type input mechanism 100-1 according to one embodiment can prevent the preceding rotation (excessive rotation) of the rotating body 105 in response to the rapid operation of the slider 103 by constantly urging the cam unit 105D in the direction of abutting on the upper sliding unit 103B, so that the rotating body 105 can reliably follow the vertical (Z-axis) sliding of the slider 103.

Furthermore, a slight opening for smoothly rotating the rotating body 105 is provided between the rotating body 105 and the components that rotatably support the rotating body 105 (the shaft unit 101C of the case 101 and the pair of supporting units 101E (see FIG. 4)). This opening may cause the rotating body 105 to wobble in the horizontal and vertical directions. Therefore, the push-type input mechanism 100-1 according to one embodiment inclines the upper sliding surface 103Ba and the upper cam surface 105Da at a predetermined inclination angle so that their height positions gradually decrease toward the outside in the radial direction of the rotating body 105. Due to this inclination, the plate thickness of the cam unit 105D in the direction of the rotation center axis (vertical direction) is set to decrease from the inside to the outside in the radial direction. This inclination, when the upper cam surface 105Da is pressed against the upper sliding surface 103Ba by the urging force from the torsion spring 105B, causes the rotating body 105 to exert a reaction force in the direction perpendicular to the inclined surface of the upper cam surface 105Da. The component of this reaction force becomes a downward (toward the supporting unit 101E) and a horizontal (toward the rotation center axis) reaction force. By this reaction force, the push-type input mechanism 100-1 according to one embodiment can bias the rotating body 105 downward (toward the supporting unit 101E) and horizontally (toward the rotation center axis) to one side within the opening between the rotating body and the component rotatably supporting the rotating body 105. Therefore, the push-type input mechanism 100-1 according to one embodiment can prevent the horizontal and vertical wobble of the rotating body 105 and stably rotate the rotating body 105. Therefore, it is possible to reliably follow the rotation operation of the rotating body 105 with respect to the vertical (Z-axis) sliding of the slider 103.

Although the rubber dome 106A is used as an example of the “dome-shaped elastic body” in the present embodiment, it is not limited to this, and as another example of the “dome-shaped elastic body”, a metal dome member capable of inverting operation or the like may be used.

Although the “cam surface” is provided on the rotating body 105 in the foregoing, it is not limited to this, and the “cam surface” may be provided on the slider 103.

### Switching Determination Performed by the Switching Determination Unit 123

The switching determination unit 123 determines the switching state of the operation knob 102 according to a majority vote based on the four outputs (detection signals) of the magnetic sensor 107C. More specifically, the sensor control unit 122 acquires the detection signal of the magnetic sensor 107C at a predetermined timing and outputs it to the switching determination unit and 123, the switching determination unit 123 determines the switching state of the operation knob 102 according to a majority vote based on the four outputs (detection signals) of the magnetic sensor 107C. Here, the four outputs of the magnetic sensor 107C will be described.

### Structure of Magnetic Sensor 107C

FIG. 10A is a drawing illustrating the configuration of the magnetic sensor 107C. The magnetic sensor 107C has four GMR sensor units 107C1-107C4. The GMR sensor units 107C1-107C4 are examples of a plurality of sensor units, and a configuration in which the magnetic sensor 107C has four GMR sensor units 107C1-107C4 will be described. The magnetic sensor 107C may have three or more GMR sensor units.

As shown in FIG. 10A, each of the GMR sensor units 107C1-107C4 has two GMR elements connected in series between the power supply Vdd and ground (GND), the GMR sensor units 107C1 and 107C2 are connected in parallel, and the GMR sensor units 107C3 and 107C4 are connected in parallel.

The resistance of each of the GMR elements of the GMR sensor unit 107C1-107C4 changes when the direction of the magnetic flux changes due to the rotation of the magnet 105A associated with the push operation of the operation knob 102, and a sine wave is output from the connection point of the two GMR elements connected in series. The polarities of the four GMR elements included in the GMR sensor units 107C1 and 107C2 are set so that the GMR sensor units 107C1 and 107C2 output the +SIN signal 1 and the −SIN signal 1 whose phases differ by 180 degrees. Similarly, the polarities of the four GMR elements included in the GMR sensor units 107C3 and 107C4 are set so that the GMR sensor units 107C3 and 107C4 output the +SIN signal 2 and the −SIN signal 2 whose phases differ by 180 degrees.

The push-type shifter device 10 can detect the rotation angle of the rotating body 105 based on the +SIN signal 1, −SIN signal 1, +SIN signal 2, and −SIN signal 2. The rotation angle of the rotating body 105 corresponds to the amount of push operation by the push operation of the operation knob 102. The amount of push operation is the amount by which the operation knob 102 is pushed down.

FIG. 10B is a drawing illustrating an example of waveforms of the +SIN signal 1 and the −SIN signal 1 output by the magnetic sensor 107C. In FIG. 10B, the horizontal axis represents the rotation angle of the magnet 105A, and the vertical axis represents the voltage values of the +SIN signal 1 and −SIN signal 1. A position (far left) where the rotation angle of the magnet 105A is −30 degrees corresponds to a state where no push operation is performed on the operation knob 102 and the amount of push operation is zero. A position (right end) where the rotation angle of the magnet 105A is +30 degrees corresponds to a state where the operation knob 102 is pushed and the operation knob 102 is completely pushed down to the lowest position. In this state, the amount of push operation is the maximum value.

As the rotation angle of the magnet 105A changes by the push operation, the +SIN signal 1 and the −SIN signal 1 change in the range of +30 degrees as shown in FIG. 10B. At this time, in the angle range AR before and after the rotation angle of the magnet 105A is zero degrees, the +SIN signal 1 and the −SIN signal 1 change linearly. As an example, the angle range AR is in the range of ±30 degrees. Here, the waveforms of the +SIN signal 1 and the −SIN signal 1 are described, but the same applies to the +SIN signal 2 and the −SIN signal 2.

It is one specific example that the +SIN signal 1 and the −SIN signal 1 change in the range of ±30 degrees as the rotation angle of the magnet 105A changes by the push operation, and the change is not limited to ±30 degrees. As long as the range of the changes of the +SIN signal 1 and the −SIN signal 1 as the rotation angle of the magnet 105A changes by the push operation is within the range where the +SIN signal 1 and the −SIN signal 1 change linearly, any range of angles may be used.

FIG. 10C is an enlarged view of the angle range AR. In FIG. 10C, the horizontal axis represents the rotation angle of the magnet 105A, and the vertical axis represents the voltage values of the +SIN signal 1 and the −SIN signal 1. FIG. 10C shows the waveforms of the +SIN signal 1 and the −SIN signal 1, and the waveforms of the +SIN signal 2 and the −SIN signal 2 are similar.

The push-type shifter device 10 determines switch on or switch off (on/off determination) by a push operation using the angle range AR in which the +SIN signal 1, the −SIN 1 signal, the +SIN signal 2, and the −SIN signal 2 output from the magnetic sensor 107C change linearly with respect to the rotation angle of the magnet 105A.

### Configuration of Peripheral Circuits of LED Elements 107B1 and 107B2

FIG. 11 is a drawing illustrating an example of a configuration of a peripheral circuit of LED elements 107B1 and 107B2 of the push-type input mechanisms 100-1 to 100-4 of the push-type shifter device 10. The peripheral circuit includes the switching elements 151-153. The push-type input mechanisms 100-1 to 100-4 have the same configuration and include one LED element 107B1 and 107B2, one switching element 151-153, and one magnetic sensor 107C.

FIG. 11 shows the LED elements 107B1, 107B2 and the switching element 151-153 of the push-type input mechanisms 100-1 and 100-4, and the LED elements 107B1, 107B2 and the switching element 151-153 of the push-type input mechanisms 100-2 and 100-3 are omitted. FIG. 11 shows the magnetic sensor 107C included as one each in the push-type input mechanisms 100-1 to 100-4.

Here, the electronic device 50 of the embodiment includes the LED element 107B1, the LED element 107B2, the switching element 151-153, and the magnetic sensor 107C of the four push-type input mechanisms 100-1 to 100-4, and the controller 120. The electronic device 50 may include at least the light emission control unit 121 and the sensor control unit 122 for the controller 120, and may not include the switching determination unit 123.

The controller 120, the LED elements 107B1 and 107B2 of the push-type input mechanisms 100-1 to 100-4, and the four magnetic sensors 107C of the push-type input mechanisms 100-1 to 100-4 are connected to the power supply 1. The output voltage of the power supply 1 is VREFH.

In the push-type input mechanisms 100-1 to 100-4, the connection relations between the LED elements 107B1 and 107B2, the switching element 151-153, the power supply 1, and the controller 120 are the same. Therefore, the connection relations and operations of the push-type input mechanism 100-1 will be described below unless otherwise noted.

The LED element 107B1 is connected between the power supply 1 and the controller 120, and the LED element 107B2 is connected in parallel with the LED element 107B1 between the power supply 1 and the controller 120.

A switching element 151 is connected between the LED element 107B1 and the controller 120. The switching element 151 is an example of a first switching element. A switching element 152 is connected between the LED element 107B1 and the power supply 1. The switching element 152 is an example of a second switching element. A switching element 153 is connected between the LED element 107B2 and the controller 120. The switching element 153 is an example of a third switching element.

### Switching Element 151 and Pwm Signal 1

The switching element 151 is driven by a pulse width modulation (PWM) signal 1 output from the light emission control unit 121 to switch the LED element 107B1 on and off, and is switched on and off. The switching element 151 is, as an example, a MOSFET (Metal Oxide Semiconductor Field-Effect Transistor).

The PWM signal 1 is an example of a first drive signal. The duty cycle of the PWM signal 1 is determined by the light emission control unit 121 in accordance with the luminance (an example of the drive level) when the LED element 107B1 is emitted. By controlling the driving of the LED element 107B1 by PWM control based on the PWM signal 1, the current flowing through the LED element 107B1 can be controlled to be constant, and the luminance can be made constant. When the LED element 107B1 is turned on by the PWM signal 1, if the switching element 151 is turned on while the switching element 152 is turned on by the switching signal, the LED element 107B1 is turned on.

### Switching Element 152 and Switching Signal

The switching element 152 is turned on and off by a switching signal output from the light emission control unit 121 in order to switch between the supply of power from the power supply 1 to the LED element 107B1 and the interruption of power. The switching signal is not a PWM signal but a switching signal for switching between the supply of power from the power supply 1 to the LED element 107B1 and the interruption of power. The switching signal is an example of a second drive signal. The switching element 152 is a PNP transistor as an example.

A switching signal for turning on the switching element 152 is output from the light emission control unit 121 to the switching element 152 of the push-type input mechanisms 100-1 to 100-4. The switching signal is switched to a level for turning on the switching element 152 during a duration from the time when the push operation is performed to the time when the push operation is stopped for the push-type input mechanism 100 (any one of 100-1 to 100-4) for which the switching determination unit 123 determines that the push operation has been performed. For the remaining three push-type input mechanisms 100 (the remaining three of the 100-1 to 100-4), the switching signal is maintained at a level that turns off the switching element 152.

As an example, since the push-type shifter device 10 is a device in which any one of the four operation knobs 102 of the four push-type input mechanisms 100-1 to 100-4 is always selected by a push operation, the switching signal is switched to a level that turns on the switching element 152 for any one of the four switching elements 152, and is maintained at a level that turns off the remaining three switching elements 152.

That is, when the LED element 107B1 of the push-type input mechanism 100 (any one of the 100-1 to 100-4) including the one operation knob 102 to which a push operation has been performed is turned on by the PWM signal 1, the switching element 152 of the push-type input mechanism 100 is turned on by the switching signal, and the switching elements 152 of the remaining three push-type input mechanisms 100 (the remaining three of the 100-1 to 100-4) are turned off by the switching signal. By driving the switching element 152 between the power supply 1 and the LED 107B1 by the switching signal, the orange LED element 107B1 is controlled so as not to turn on by mistake when the respective push-type input devices 100 fall into an abnormal state that cannot be seen in normal operation. Although an example of the switching element 152 provided in the respective push-type input mechanisms 100 has been described, the switching element 152 may be provided in any one of the four push-type input mechanisms 100-1 to 100-4, and the output signal of the switching element 152 may be output to the LED elements 107B1 of the remaining three push-type input mechanisms.

### Switching Element 153 and PWM Signal 2

The switching element 153 is driven by the PWM signal 2 output from the light emission control unit 121 to switch the LED element 107B2 on and off, and is switched on and off. The switching element 153 is, as an example, a MOSFET.

The PWM signal 2 is an example of a third drive signal. The duty cycle of the PWM signal 2 is determined by the light emission control unit 121 according to the luminance (an example of the drive level) when the LED element 107B2 is emitted. When the switching element 153 is turned on, the LED element 107B2 is turned on. By driving the LED element 107B2 under control by the PWM signal 2, the current flowing through the LED element 107B2 can be controlled to be constant current, and the luminance can be made constant.

### Operation of LED Elements 107B1, 107B2 Throughout Push-Type Input Mechanisms 100-1 to 100-4

In the entire push-type input mechanisms 100-1 to 100-4, the orange LED element 107B1 of the push-type input mechanism (any one of 100-1 to 100-4) including the one operation knob 102 to which the push operation has been performed is turned on, and the white LED element 107B2 of the push-type input mechanism (the remaining three of 100-1 to 100-4) including the three operation knobs 102 to which the push operation has not been performed is turned on. Therefore, to the push-type input mechanism (any one of 100-1 to 100-4) including the one operation knob 102 to which the push operation has been performed, a PWM signal 1 for turning on the switching element 151, a switching signal for turning on the switching element 152, and a PWM signal 2 for turning off the switching element 153 are outputted from the light emission control unit 121. Further, to the push-type input mechanisms (the remaining three of the operation knobs 100-1 to 100-4) including the three not subjected to the push operation knobs 102 operation, the light emission control unit 121 outputs a PWM signal 1 to turn off the switching element 151, a switching signal to turn off the switching element 152, and a PWM signal 2 to turn on the switching element 153.

That is, in the entire push-type input mechanisms 100-1 to 100-4, the light emission control unit 121 outputs one PWM signal 1 for turning on one orange LED element 107B1 and three PWM signals 2 for turning on three white LED elements 107B2.

The reason why the switching element 152 is provided only between the orange LED element 107B1 and the power supply 1 is that the switching element 152 cuts off the power supply path to the orange LED element 107B1 so that the orange LED element 107B1 is not turned on by mistake when the push-type input device 100 falls into an abnormal state that cannot be seen in normal operation.

### Variation of Voltage VREFH of Power Supply 1

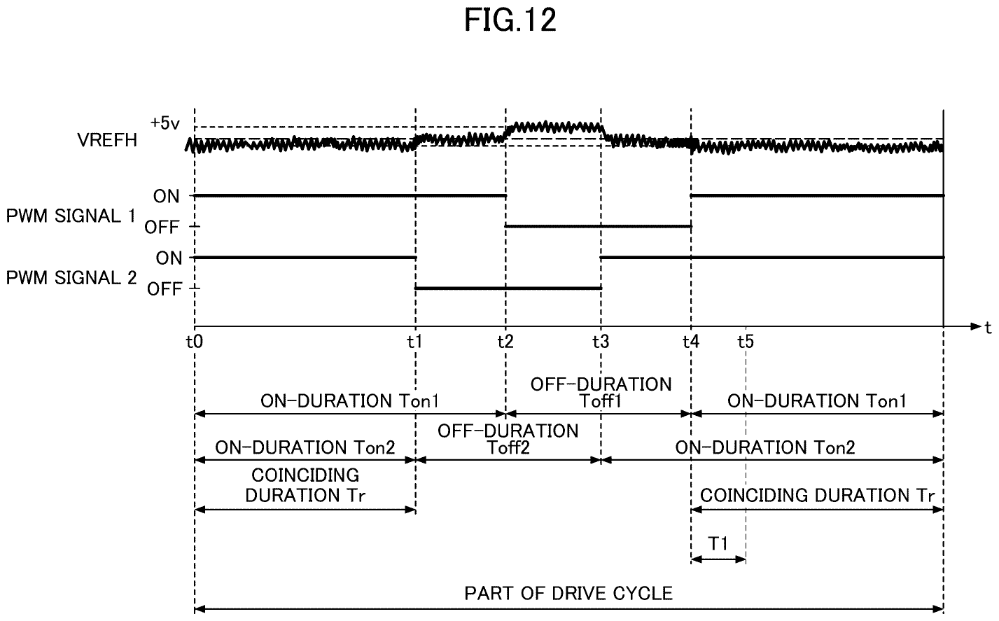

FIG. 12 is a drawing illustrating the output voltage VREFH of the power supply 1, and a part of a drive cycle of the PWM signal 1 and PWM signal 2, which have cyclicity. In FIG. 12, the horizontal axis represents time, and the vertical axis represents the voltage value of the output voltage VREFH and the signal levels (on and off) of the PWM signal 1 and the PWM signal 2. On represents H (high) level, and off represents L (low) level.

Here, as an example, a case where a push operation is performed on the operation knob 102 of the push-type input mechanism 100-1 will be described. The PWM signal 1 shown in FIG. 12 is a PWM signal that the light emission control unit 121 outputs to turn on the orange LED element 107B1 of the push-type input mechanism 100-1. Further, since the three PWM signals 2 that the light emission control unit 121 outputs to turn on the white LED element 107B2 of the push-type input mechanisms 100-2 to 100-4 are switched on and off at the same timing, FIG. 12 shows the PWM signal 2 that the light emission control unit 121 outputs to the push-type input mechanism 100-2, and the PWM signal 2 that is output to the push-type input functions 100-3 and 100-4 is omitted. The PWM signal 2 that drives the white LED element 107B2 of the push-type input mechanism 100-1 and the PWM signal 1 that drives the orange LED element 107B1 of the push-type input mechanisms 100-2 to 100-4 are also omitted.

FIG. 12 shows an on-duration (on-duration Ton1) in which the PWM signal 1 for driving the orange LED element 107B1 of the push-type input mechanism 100-1 is turned on, and an off-duration (off-duration Toff1) in which the PWM signal 1 is turned off. Similarly, an on-duration (on-duration Ton2) in which the PWM signal 2 for driving the white LED element 107B2 of the push-type input mechanism 100-2 is turned on, and an off-duration (off-duration Toff2) in which the PWM signal 2 is turned off are shown.

One cycle (drive cycle) of the PWM signal 1 and the PWM signal 2 is equal, the duty cycles of the PWM signal 1 and the PWM signal 2 are equal, and the on and off timings of the PWM signal 1 and the PWM signal 2 are different from each other. FIG. 12 shows, as an example, a case where one cycle (on-duration and off-duration) of the PWM signal 1 and the PWM signal 2 is 5 ms. It is to be noted that the duty cycle of the PWM signal 1 and the PWM signal 2 may be adjusted according to the required luminance, but here, as an example, the duty cycle is 85%.

As an example, the output voltage VREFH of the power supply 1 is converted to 5 V (output voltage 5 V) by a voltage converter or the like from a power source such as a battery of a vehicle and supplied thereto. Since the output voltage VREFH of the power supply 1 is supplied to the controller 120, the LED elements 107B1 and 107B2 of the push-type input mechanisms 100-1 to 100-4, and the sensor 107C of the push-type input mechanisms 100-1 to 100-4, the output voltage VREFH varies depending on the on and off states of the LED elements 107B1 and 107B2.

As shown in FIG. 12, at time to, both the PWM signal 1 and the PWM signal 2 are on. That is, the orange LED element 107B1 of the push-type input mechanism 100-1 and the three white LED elements 107B2 of the push-type input mechanisms 100-2 to 100-4 are emitting light. In this state, the output voltage VREFH is lower than 5 V, for example, approximately 4.9 V.

At time t1, when the PWM signal 2 is switched from on to off, the three white LED elements 107B2 of the push-type input mechanisms 100-2 to 100-4 are turned off, that is, the current load becomes small, and the output voltage VREFH increases. Here, in order to prevent the fluctuation of the output voltage VREFH, the timings at which the three PWM signals 2 and the PWM signal 1 are switched on and off are shifted. That is, the timings at which the three PWM signals 2 and the PWM signal 1 are switched on and off are different from each other. However, the time difference between the timings at which the three PWM signals 2 and the PWM signal 1 are switched on and off is too short for human eyes to recognize.

At time t2, when the PWM signal 1 is switched from on to off while the PWM signal 2 is off, the orange LED element 107B1 of the push-type input mechanism 100-1 is turned off, and the output voltage VREFH further rises a little to return to 5 V.

At time t3, when the PWM signal 2 is switched from off to on, the three white LED elements 107B2 of the push-type input mechanisms 100-2 to 100-4 are turned on, and the output voltage VRE FH decreases.

At time t4, when the PWM signal 1 is switched from off to on while the PWM signal 2 is on, the orange LED element 107B1 of the push-type input mechanism 100-1 is turned on, and the output voltage VREFH further slightly decreases.

As described above, in a vehicle, power is supplied from a power source such as a battery, and since the amount of supplied power is limited, a voltage fluctuation occurs in the output voltage VREFH by turning on and off the LED elements 107B1 and 107B2. When a voltage fluctuation occurs in the output voltage VREFH, the voltage supplied to the magnetic sensor 107C fluctuates, SO that the detection value acquired from the magnetic sensor 107C fluctuates.

### Consideration of Push-Type Shifter Device for Comparison

Here, a push-type shifter device for comparison will be examined. The push-type shifter device for comparison acquires (samples) a detection value from the magnetic sensor 107C in a predetermined sampling cycle that is not associated with a drive cycle in which the LED elements 107B1 and 107B2 are turned on and off. If the drive cycle in which the LED elements 107B1 and 107B2 are turned on and off is different from the predetermined sampling cycle in which the detection value is acquired from the magnetic sensor 107C, the timing at which the detection value of the magnetic sensor 107C is acquired shifts in the drive cycle as time elapses. Therefore, the timing at which the detection value of the magnetic sensor 107C is acquired varies, such as the timing at which the LED elements 107B1 and 107B2 are turned on, the timing at which the LED elements 107B1 and 107B2 are turned off, or the timing at which only one of the LED elements 107B1 and 107B2 is turned on. In such a state, even if the amount of push operation of the operation knob 102 is constant, there is a possibility that the detection value of the magnetic sensor 107C varies each time the detection value is acquired in a predetermined sampling cycle. This is because the output voltage VREFH differs each time the detection value of the magnetic sensor 107C is acquired due to a voltage fluctuation of the output voltage VREFH.

The above-described variation in the detection value of the magnetic sensor 107C in the push-type shifter device for comparison may lead to erroneous determination of the switching state of the operation knob 102.

Therefore, in the push-type shifter device 10 of the embodiment, in order to enable the detection value of the magnetic sensor 107C to be acquired with stable accuracy even when the output voltage VREFH varies, the sensor control unit 122 acquires the detection value of the magnetic sensor 107C at a timing described below. Thus, erroneous determination of the switching state of the operation knob 102 is prevented.

### Timing at Which the Sensor Control Unit 122 Acquires the Detection Value of the Magnetic Sensor 107C

The sensor control unit 122 acquires the detection value of the magnetic sensor 107C at a time t5 at which a predetermined time T1 has elapsed from a time t4 at which the LED element 107B1 is turned on later than the LED element 107B2 during the coinciding duration Tr of the on-duration Ton1 and the on-duration Ton2 shown in FIG. 12.

The reason why the detected value of the magnetic sensor 107C is acquired within the coinciding duration Tr is that the LED elements 107B1 and 107B2 are both turned on and the output voltage VREFH is stabilized. The reason why the detected value of the magnetic sensor 107C is acquired at a time t5 when a predetermined time T1 elapses from a time t4 when the LED element 107B1 is turned on later than the LED element 107B2 is that the output voltage VREFH fluctuates immediately after the LED element 107B1 is turned on, so that the detected value of the magnetic sensor 107C is acquired with stable accuracy when the output voltage VREFH is stabilized after a little time has passed. The predetermined time T1 may be equal to or longer than the time required from the time when the LED element 107B1 is turned on until the output voltage VREFH is stabilized, and may be equal to or shorter than the time when the LED element 107B2 is turned off. That is, the predetermined time T1 may be equal to or shorter than the time from a time t4 when the LED element 107B1 is turned on later than the LED element 107B2 to a time t1 when the PWM signal 2 is switched from on to off in the next drive cycle.

The reason why the detected value of the magnetic sensor 107C is acquired in the coinciding duration Tr when both the LED elements 107B1 and 107B2 are turned on is that the duty cycle of the PWM signal 1 and the PWM signal 2 is large, and the on-durations Ton1 and Ton2 are longer than the off-durations Toff1 and Toff2 in one drive cycle, so that the detected value of the magnetic sensor 107C is more stably and reliably acquired in the coinciding duration Tr of the longer on-durations Ton1 and Ton2.

Although the mode of acquiring the detected value of the magnetic sensor 107C in the coinciding duration Tr when both the LED elements 107B1 and 107B2 are turned on will be described herein, the detected value of the magnetic sensor 107C may be acquired at the timing when the output voltage VREFH is stabilized based on the on/off duty of the PWM1 signal and the PWM2 signal. Also, the detected value of the magnetic sensor 107C may be acquired in the duration when both the LED elements 107B1 and 107B2 are turned off. This is because the output voltage VREFH is stable even in the duration when both the LED elements 107B1 and 107B2 are turned off, and the detected value of the magnetic sensor 107C can be stably acquired.

### Timing Setting to Acquire Detected Value

In the push-type shifter device 10 of the embodiment, in order to acquire a detected value of the magnetic sensor 107C at time t5, a processing to notify the sensor control unit 122 of a timing to acquire a detected value of the magnetic sensor 107C by interrupt processing is included in a processing table to manage a processing in which the light emission control unit 121 sequentially turns on the LED elements 107B1 and 107B2.

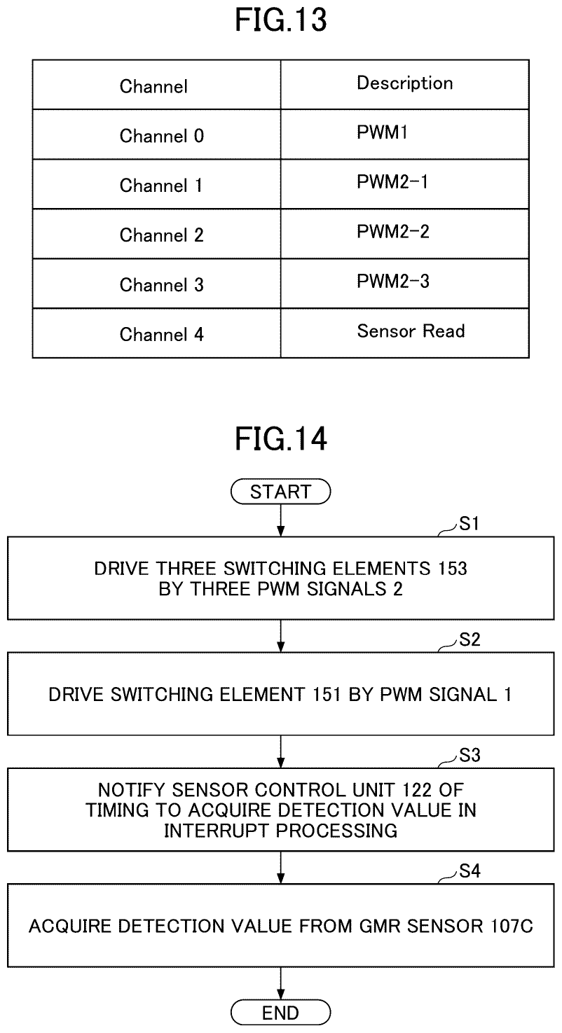

FIG. 13 is a drawing illustrating an example of the processing table of the light emission control unit 121. The processing table of the light emission control unit 121 is table format data to store descriptions to be executed by the light emission control unit 121 in one drive cycle.

The processing table of the light emission control unit 121 includes, as an example, 5 channels, and a description to drive the switching element 151 by the PWM signal 1 is registered in the channel 0 for the push-type input mechanism (any one of 100-1 to 100-4) including the one operation knob 102 to which the push The operation is performed. descriptions to drive the switching element 153 by the three PWM signals 2-1 to 2-3 are registered in the channel 1-3 for the push-type input mechanisms (the remaining three of 100-1 to 100-4) including the three operation knobs 102 to which the push operation is not performed. Here, for convenience of explanation, the three PWM signals 2 are divided into PWM signals 2-1 to 2-3.

Further, an interrupt processing (Sensor Read) to notify the sensor control unit 122 of the timing of acquiring the detection value of the magnetic sensor 107C is registered in the channel 4. Such an interrupt processing may be registered in an empty channel in the processing table of the light emission control unit 121. The interrupt processing for notifying the sensor control unit 122 of the timing of acquiring the detection value of the magnetic sensor 107C may be set so that notification is performed at time t5 shown in FIG. 12.

Thus, if the interrupt processing for notifying the sensor control unit 122 of the timing of acquiring the detection value of the magnetic sensor 107C is included in the processing table of the light emission control unit 121, the light emission control unit 121 repeatedly executes the interrupt processing of the channel 4 every drive cycle, so that the sensor control unit 122 can acquire the detection value of the magnetic sensor 107C at the timing corresponding to time t5 shown in FIG. 12 every drive cycle.

The actual processing table of the light emission control unit 121 includes information other than the channels and the descriptions, but this is omitted here.

### Flowchart

FIG. 14 is a flowchart illustrating the processing executed by the light emission control unit 121 and the sensor control unit 122 of the controller 120. Here, the processing executed by the light emission control unit 121 and the sensor control unit 122 for each drive cycle will be described. As an example, a case where a push operation is performed on the operation knob 102 of the push-type input mechanism 100-1 will be described.

When the processing is started, the light emission control unit 121 drives the three switching elements 153 of the push-type input mechanisms 100-2 to 100-4 by three PWM signals 2-1 to 2-3 in accordance with the descriptions of the channels 1-3 (step S1). As a result, the three white LED elements 107B2 of the push-type input mechanisms 100-2 to 100-4 are turned on.

The light emission control unit 121 drives the switching element 151 of the push-type input mechanism 100-1 by a PWM signal 1 in accordance with the description of the channel 0 (step S2). As a result, the orange LED element 107B1 of the push-type input mechanism 100-1 is turned on.

In accordance with the description of the channel 4, the light emission control unit 121 executes an interrupt processing to notify the sensor control unit 122 of the timing to acquire the detection value of the magnetic sensor 107C (step S3).

The sensor control unit 122 acquires the detection value of the magnetic sensor 107C at a timing corresponding to time t5 shown in FIG. 12 in the drive cycle (step S4). That is, the sensor control unit 122 acquires the detection value from the magnetic sensor 107C in synchronization with the drive cycle in which the light emission control unit 121 controls the driving of the LED elements 107B1 and 107B2.

Thus the processing of steps S1 to S4 in one drive cycle is completed. The light emission control unit 121 and the sensor control unit 122 of the controller 120 repeatedly execute the processing shown in FIG. 14 for each drive cycle.

### Effect

The electronic device 50 includes a magnetic sensor 107C connected to the power supply 1, an LED element 107B1 connected to the power supply 1, a sensor control unit 122 to control the magnetic sensor 107C, and a light emission control unit 121 to control the driving of the LED element 107B1. The sensor control unit 122 acquires a detection value from the magnetic sensor 107C in synchronization with a drive cycle in which the light emission control unit 121 controls the driving of the LED element 107B1.

Therefore, in each drive cycle, the detection value can be acquired from the magnetic sensor 107C with stable accuracy while the output voltage VREFH of the power supply 1 is stable.

Therefore, it is possible to provide the electronic device 50 capable of acquiring the detection value of the magnetic sensor 107C with stable accuracy while preventing the influence of the fluctuation of the power supply voltage VREFH. It is also possible to provide the push-type shifter device 10 including the electronic device 50 capable of acquiring the detection value of the magnetic sensor 107C with stable accuracy while preventing the influence of the fluctuation of the power supply voltage VREFH.

The electronic device 50 further includes a switching element 151 connected between the LED element 107B1 and the light emission control unit 121, and the light emission control unit 121 drives the switching element 151 with the PWM signal 1, thereby controlling the driving of the LED element 107B1.

Since the driving of the LED element 107B1 can be controlled by the PWM control based on the PWM signal 1, the current flowing through the LED element 107B1 can be controlled by a constant current, and the luminance can be made constant.

In addition, the sensor control unit 122 acquires a detection value in an on-duration Ton1 in which the LED element 107B1 is turned on in a drive cycle in which the light emission control unit 121 controls the drive of the LED element 107B1. Therefore, it is possible to provide an electronic device 50 capable of acquiring the detection value of the magnetic sensor 107C with stable accuracy by preventing the influence of the fluctuation of the power supply voltage VREFH in a state where the power supply voltage VREFH is stabilized in the on-duration Ton1 of the LED element 107B1.

The sensor control unit 122 acquires a detection value at a time t5 when a predetermined time T1 has elapsed since the light emission control unit 121 turned on the LED element 107B1 in the on-duration Ton1. By leaving a predetermined time T1 after the LED element 107B1 is turned on, the fluctuation of the power supply voltage VREFH is stabilized, and the detection value is acquired at a stable timing, whereby the variation of the detection value can be prevented.

The electronic device 50 further includes a switching element 152 connected between the LED element 107B1 and the power supply 1, and the light emission control unit 121 drives the switching element 151 by the PWM signal 1 and drives the switching element 152 by the switching signal, thereby controlling the driving of the LED element 107B1.

When the switching signal switches between on and off of the switching element 152 located between the power supply 1 and the LED element 107B1, a current is supplied to the LED element 107B1 from the power supply 1. Therefore, when each push-type input device 100 falls into an abnormal state that cannot be seen in normal operation, the switching element 152 can cut off the power supply path to the orange LED element 107B1 so that the orange LED element 107B1 is not turned on by mistake.

The electronic device 50 further includes an LED element 107B2 connected to the power supply 1 and a switching element 153 connected between the LED element 107B2 and the light emission control unit 121, and the light emission control unit 121 drives the switching element 153 by the PWM signal 2 to control the driving of the LED element 107B2.

Therefore, the light emission control unit 121 can simultaneously control the driving of the LED elements 107B1 and 107B2, and can provide a visual distinction to the operator by the light emission of the LED elements 107B1 and 107B2.

The sensor control unit 122 acquires a detection value from the magnetic sensor 107C in synchronization with a drive cycle in which the light emission control unit 121 controls the driving of the LED element 107B1 and the LED element 107B2.

Therefore, it is possible to provide an electronic device 50 which can acquire a detection value from the magnetic sensor 107C with stable accuracy in a state where the output voltage VREFH of the power supply 1 is stable in synchronization with a drive cycle in which the driving control of the LED element 107B1 and the LED element 107B2 is performed for each drive cycle, and can acquire the detection value of the magnetic sensor 107C with more stable accuracy. Further, it is possible to provide the push-type shifter device 10 including the electronic device 50 capable of obtaining the detection value of the magnetic sensor 107C with stable accuracy by preventing the influence of the fluctuation of the power supply voltage VREFH.

In addition, the sensor control unit 122 acquires a detection value from the magnetic sensor 107C in the coinciding duration Tr during which the LED element 107B1 and the LED element 107B2 are turned on in a drive cycle in which the light emission control unit 121 controls the driving of the LED element 107B1 and the LED element 107B2.

When the duty of the PWM signal 1 and the PWM signal 2 to drive the LED element 107B1 and the LED element 107B2 is large, the detection value can be stably acquired from the magnetic sensor 107C in a longer on-duration Ton1 and Ton2.

Further, the PWM signal 1 and the PWM signal 2 are pulse width modulation signals to control the drive levels of the LED element 107B1 and the LED element 107B2, respectively, and the switching signal is a switching signal to switch between supply and interruption of power from the power supply 1 to the LED element 107B1. The current flowing through the LED element 107B1 and the LED element 107B2 can be controlled by a constant current, and the luminance can be made constant.

Also, since the timings at which the PWM signals 1 and 2 turn on the LED element 107B1 and the LED element 107B2 are different from each other, the fluctuation of the output voltage VREFH of the power supply 1 can be prevented, and the output voltage VREFH of the power supply 1 can be stabilized at an early stage, and the detection value can be more stably acquired from the magnetic sensor 107C. In particular, when the number of the push-type input mechanisms 100 is large, the fluctuation of the output voltage VREFH of the power supply 1 caused by the turning on and off of the LED element 107B2 becomes large, so that it is very effective that the timings at which the PWM signal 1 and the PWM signal 2 turn on the LED element 107B1 and the LED element 107B2 are different from each other.

Since the electronic device 50 includes a plurality of the sets of LED elements 107B1, switching elements 151, switching elements 152, LED elements 107B2, and switching elements 153, it is possible to cope with a configuration including a plurality of push-type input mechanisms 100. Further, when the number of push-type input mechanisms 100 is large, the fluctuation of the output voltage VREFH of the power supply 1 caused by the on and off state of the LED elements 107B2 becomes larger, and therefore, the effect of obtaining the detected value from the magnetic sensor 107C in synchronization with the drive cycle of the LED elements 107B1 becomes larger. Therefore, even when the number of push-type input mechanisms 100 is large and the fluctuation of the output voltage VREFH of the power supply 1 becomes larger, the detected value can be obtained from the magnetic sensor 107C with stable accuracy every drive cycle.

A push-type shifter device 10 includes an operation knob 102 which is pushed by an operator, a rubber dome 106A which imparts a click feeling to the push operation, a slider 103 which slides in a predetermined sliding direction in accordance with the push operation, a rotating body 105 which rotates in accordance with the slide of the slider 103, a magnetic sensor 107C which is connected to a power source 1 and detects a measurement value corresponding to the rotation angle of the rotating body 105, an LED element 107B1 which is connected to the power source 1, a sensor control unit 122 which controls the magnetic sensor 107C, and a light emission control unit 121 which controls the driving of the LED element 107B1. The sensor control unit 122 acquires a detection value from the magnetic sensor 107C in synchronization with a drive cycle in which the light emission control unit 121 controls the driving of the LED element 107B1.

Therefore, the detection value can be acquired from the magnetic sensor 107C with stable accuracy in a state where the output voltage VREFH of the power supply 1 is stable every drive cycle.

Therefore, it is possible to provide the push-type shifter device 10 capable of obtaining the detected value of the magnetic sensor 107C with stable accuracy by preventing the influence of the fluctuation of the power supply voltage VREFH.

Further, since the push-type shifter device 10 includes a plurality of sets of the operation knob 102, the rubber dome 106A, the slider 103, the rotating body 105, the magnetic sensor 107C, and the LED element 107B1, it is possible to cope with a configuration including a plurality of operation knobs 102.

The push-type shifter device 10 is a push-type shifter device 10 including the operation knob 102 for selecting the shift position of the vehicle, and includes the magnetic sensor 107C connected to the power supply 1 and detecting the measured value according to the operation position of the operation knob 102, the LED element 107B1 connected to the power supply 1, the sensor control unit 122 for controlling the magnetic sensor 107C, and the light emission control unit 121 for controlling the driving of the LED element 107B1. The sensor control unit 122 acquires the detected value from the magnetic sensor 107C in synchronization with a drive cycle in which the light emission control unit 121 controls the driving of the LED element 107B1.

Therefore, the detected value can be acquired from the magnetic sensor 107C with stable accuracy in a state where the output voltage VREFH of the power supply 1 is stable every drive cycle.

Therefore, the push-type shifter device 10 capable of acquiring the detected value of the magnetic sensor 107C with stable accuracy by preventing the influence of the fluctuation of the power supply voltage VREFH can be provided.

Further, since a plurality of operation knobs 102 are provided to select a plurality of shift positions of the vehicle and a plurality of sets of the magnetic sensor 107C and the LED element 107B1 are included corresponding to the plurality of operation knobs 102, a configuration including a plurality of operation knobs 102 can be accommodated.

### Variation

The electronic device 50 and the push-type shifter device 10 (push-type input device and one example of electronic shifter) of the embodiment have been described above, but the modification may be made as follows.

Instead of acquiring the detection value of the magnetic sensor 107C in a state where the LED elements 107B1 and 107B2 are on, the detection value of the magnetic sensor 107C may be acquired in a state where the voltage VREFH is returned to 5 V in a state where the LED elements 107B1 and 107B2 are off.

Although the embodiment in which the first load and the second load are the LED element 107B1 and the LED element 107B2 has been described above, at least one of the first load and the second load may not be an LED, and may be, for example, a motor or an electromagnet.

Further, although the mode in which the sensor control unit 122 obtains the detection value of the magnetic sensor 107C has been described above, an electrostatic sensor, a piezoelectric sensor, a strain sensor, or the like may be used in place of the magnetic sensor 107C.

Further, although the mode in which the push-type shifter device 10 has a plurality of shift positions and the operation knob 102 corresponding to each shift position has been described above, the push-type shifter device 10 may be configured to include only one operation knob 102. For example, the configuration may be such that two shift positions, the parking position and the drive position, can be operated by switching on and off of one operation knob 102. As an example, the configuration may be such that when the operation knob 102 is not pushed, the parking position is set, and when the push operation is performed, the driving position is switched.

The electronic device, the push-type input device, and the electronic shifter according to the present disclosure are described above, and the present invention is not limited to the embodiments disclosed specifically, but various variations and modifications may be made without departing from the scope of the present invention.

What is claimed is:

1. An electronic device comprising:
a sensor connected to a power supply;
a first load connected to the power supply;
a sensor control unit configured to control the sensor; and
a drive control unit configured to control drive of the first load,
wherein the sensor control unit is configured to acquire a detection value from the sensor in synchronization with a drive cycle by which the drive control unit performs drive control of the first load.

2. The electronic device according to claim 1, further comprising a first switching element connected between the first load and the drive control unit, wherein the drive control unit is configured to perform the drive control of the first load by driving the first switching element with a first drive signal.

3. The electronic device according to claim 1, wherein the sensor control unit is configured to acquire the detection value during an on-duration in which the first load is on in the drive cycle by which the drive control unit performs the drive control of the first load.

4. The electronic device according to claim 3, wherein the sensor control unit is configured to acquire the detection value when a predetermined duration required for an output voltage to stabilize has elapsed, after the drive control unit turns on the first load.

5. The electronic device according to claim 2, further comprising a second switching element connected between the first load and the power supply, wherein the drive control unit is configured to perform the drive control of the first load by driving the first switching element with the first drive signal, and driving the second switching element with a second drive signal.

6. The electronic device according to claim 5, further comprising:
a second load connected to the power supply; and
a third switching element connected between the second load and the drive control unit,
wherein the drive control unit is configured to perform the drive control of the second load by driving the third switching element with a third drive signal.

7. The electronic device according to claim 6, wherein the sensor control unit is configured to acquire the detection value from the sensor in synchronization with the drive cycle by which the drive control unit performs the drive control of the first load and the second load.

8. The electronic device according to claim 7, wherein the sensor control unit is configured to acquire the detection value from the sensor during an on-duration in which the first load and the second load are on in the drive cycle by which the drive control unit performs the drive control of the first load and the second load.

9. The electronic device according to claim 6, wherein the first drive signal and the third drive signal are pulse width modulation signals configured to control drive levels of the first load and the second load, respectively, and wherein the second drive signal is a switching signal configured to switch between supplying and interrupting power from the power supply to the first load.

10. The electronic device according to claim 6, wherein a timing at which the first drive signal and the third drive signal turn on the first load and the second load, respectively, differs.

11. The electronic device according to claim 6, comprising a plurality of sets of the first load, the first switching element, the second switching element, the second load, and the third switching element.

12. A push-type input device comprising:
a switch to which a push operation is performed by an operator;
a click feeling imparting mechanism configured to impart a click feeling to the push operation;
a slider configured to perform a slide in a predetermined sliding direction in accordance with the push operation;
a rotating body configured to rotate in accordance with the slide of the slider;
a sensor connected to a power source and configured to detect a measurement value corresponding to a rotation angle of the rotating body;
a first load connected to the power source;
a sensor control unit configured to control the sensor; and
a drive control unit configured to perform drive control of the first load,
wherein the sensor control unit is configured to acquire a detection value from the sensor in synchronization with a drive cycle by which the drive control unit performs the drive control of the first load.

13. The push-type input device according to claim 12, comprising a plurality of sets of the switch, the click feeling imparting mechanism, the slider, the rotating body, the sensor, and the first load.

14. An electronic shifter including a switch configured to select a shift position of a vehicle, comprising:
a sensor connected to a power source and configured to detect a measurement value corresponding to an operating position of the switch;
a first load connected to the power source;
a sensor control unit configured to control the sensor; and
a drive control unit configured to perform drive control of the first load,
wherein the sensor control unit is configured to acquire a detection value from the sensor in synchronization with a drive cycle by which the drive control unit performs the drive control of the first load.

15. The electronic shifter according to claim 14, comprising a plurality of sets of the sensor and the first load corresponding to a plurality of switches, wherein the plurality of the switches are provided to select a plurality of shift positions of the vehicle.
